(19) United States
(12) Patent Application Publication
(10) Pub. No.: US 2026/0230531 A1
(43) Pub. Date: Aug. 6, 2026

(54) HANDLING DYNAMIC INSTANTIATION OF EDGE APPLICATION SERVER (EAS) IN AN EDGE NETWORK

(71) Applicant: Samsung Electronics Co., Ltd., Suwon-si, Gyeonggi-do (KR)

(72) Inventors: Basavaraj Jayawant PATTAN, Bangalore (IN); Sapan Pramodkumar SHAH, Bangalore (IN)

(21) Appl. No.: 19/146,371

(22) PCT Filed: Jan. 9, 2024
(86) PCT No.: PCT/KR2024/000401

§ 371 Date: Jul. 8, 2025

(30) Foreign Application Priority Data
Jan. 9, 2023 (IN) 202341001871
Dec. 27, 2023 (IN) 202341001871

(51) Int. Cl. H04L 67/51; H04L 41/0806; H04L 67/303

(52) U.S. Cl. CPC H04L 67/51; H04L 41/0806; H04L 67/303

(57) ABSTRACT

The disclosure relates to a 5G or 6G communication system for supporting a higher data transmission rate. Embodiments disclosed herein provide a method for handling dynamic instantiation of an EAS (300) in an EDN (1000) by an EEC (400). The method includes receiving a first message from an ECS (600) or an EES (500). The first message includes instantiable EAS information indicating an EAS instantiation status per EAS of a list of EASs and an instantiable criteria upon which the EAS (300) of the list of EASs is instantiable. Further, the method includes selecting at least one EAS (300) from the list of EASs or at least one EES to select the at least one EAS based on the instantiable EAS information and the instantiable criteria. Further, the method includes performing an EAS discovery of the at least one selected EAS based on the instantiable EAS information.

### TECHNICAL FIELD

The embodiments disclosed herein generally relate to field of an edge computing service. The invention relates to system and method for enhancing dynamic instantiation of Edge Application Server (EAS).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

Nowadays, an edge computing service is used as a distributed Information Technology (IT) architecture which moves computing resources from clouds and data centers as close as possible to an originating source. The edge computing is utilized to reduce latency requirements while processing data and saving network costs. An Edge Enabler Server (EES) triggers an Edge Application Server (EAS) instantiation dynamically due to e.g., EAS discovery request, User Equipment (UE) mobility, upon receiving an Edge Enabler Client (EEC) Registration request containing application client (AC) profile. The EAS discovery request is received with an EAS discovery filter from the EEC or the S-EES during the procedures for EAS discovery. The EES may fail to discover and select the EAS that matches the UE location and the requesting application characteristics due to no EAS is available or instantiated.

The above information is presented as background information only to help the reader to understand the present invention. Applicants have made no determination and make no assertion as to whether any of the above might be applicable as prior art with regard to the present application.

### DISCLOSURE OF INVENTION

### Technical Problem

The present disclosure relates to handling dynamic instantiation of an EAS in an edge data network (EDN) and, more specifically, the present disclosure relates to handling dynamic instantiation of an EAS is performed in an edge data network (EDN) to avoid waste of EDN resources.

### Solution to Problem

In one embodiment, a method is provided. The method comprises receiving, a first message including at least one of instantiable EAS information indicating an EAS instantiation status per EAS of a list of EASs and an instantiable criteria associated with the instantiation of the EAS of the list of EASs, selecting at least one EAS or at least one EES, based on the at least one of the instantiable EAS information and the instantiable criteria and performing an EAS discovery of the at least one selected EAS.

In another embodiment, the EEC is provided. The EEC comprises a transceiver, and at least one processor configured to receive, via the transceiver, a first message including at least one of instantiable EAS information indicating an EAS instantiation status per EAS of a list of EASs and an instantiable criteria associated with the instantiation of the EAS of the list of EASs, select at least one EAS or at least one EES, based on the at least one of the instantiable EAS information and the instantiable criteria, and perform an EAS discovery of the at least one selected EAS.

### Advantageous Effects of Invention

According to an embodiment of present disclosure, an wastage of EDN resources is avoided.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates an EAS handles dynamic instantiation in an EDN, according to the embodiments as disclosed herein;

FIG. 2 illustrates various hardware components of an EEC, according to the embodiments as disclosed herein;

FIG. 3 illustrates various hardware components of an EES, according to the embodiments as disclosed herein;

FIG. 4 illustrates various hardware components of an ECS, according to the embodiments as disclosed herein;

FIG. 5 illustrates an example illustration in which the ECS sharing instantiable criteria to the EEC via service provisioning is depicted, according to the embodiments as disclosed herein;

FIG. 6 illustrates an example illustration in which the EES sharing the instantiable criteria to the EEC via the EAS discovery response is depicted, according to the embodiments as disclosed herein;

FIG. 7 illustrates an example illustration in which the EES sharing the instantiable criteria to the EEC via the EAS discovery notification is depicted, according to the embodiments as disclosed herein;

FIG. 8 illustrates an example illustration in which the EEC requesting the EES to notify any change in the instantiable EAS information is depicted, according to the embodiments as disclosed herein;

FIG. 9 illustrates an example illustration in which the EEC selected EAS information sharing to the EES for dynamic EAS instantiation is depicted, according to the embodiments as disclosed herein;

FIG. 10 illustrates a flow chart illustrating a method, implemented by the EEC, for handling dynamic instantiation of the EAS in the EDN, according to the embodiments as disclosed herein;

FIG. 11 illustrates a flow chart illustrating a method, implemented by the EES, for handling dynamic instantiation of the EAS in the EDN, according to the embodiments as disclosed herein; and

FIG. 12 illustrates a flow chart illustrating a method, implemented by the ECS, for handling dynamic instantiation of the EAS in the EDN, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The principal object of the embodiments herein is to provide a method for handling dynamic instantiation of an EAS in an edge data network (EDN).

Another object of the embodiments herein is to provide that an Edge Configuration Server (ECS) shares instantiable criteria to an EEC via a service provisioning response message.

Another object of the embodiments herein is to provide that an EES shares instantiable criteria to the EEC via an EAS discovery response message.

Another object of the embodiments herein is to provide that the EES shares the instantiable criteria to the EEC via an EAS discovery notification message.

Another object of the embodiments herein is to provide that the EEC requests the EES to notify any change in instantiable EAS information.

Another object of the embodiments herein is to provide that the EEC selected EAS information shares to the EES for dynamic EAS instantiation.

Another object of the embodiments herein is to enhance dynamic instantiation of an EAS in the EDN.

Another object of the embodiments herein is to provide sufficient information to the EES and the EEC for considering, prior to initiating dynamic instantiation of EAS, EAS discovery and selection of EAS identifier (ID) during EAS information provisioning request, to avoid wastage of EDN resources.

Embodiments disclosed herein provide a method for handling dynamic instantiation of an EAS in an EDN. The method includes receiving, by an Edge Enabler Client (EEC), a first message from an Edge Configuration Server (ECS) or an Edge Enabler Server (EES). The first message includes instantiable EAS information indicating an EAS instantiation status per EAS of a list of EASs and an instantiable criteria upon which the EAS of the list of EASs is instantiable. Further, the method includes selecting, by the EEC, at least one EAS from the list of EASs or at least one EES to select the at least one EAS based on the instantiable EAS information and the instantiable criteria. Further, the method includes performing, by the EEC, an EAS discovery of the at least one selected EAS based on the instantiable EAS information.

In an embodiment, performing, by the EEC, the EAS discovery of the at least one selected EAS based on the instantiable EAS information includes determining, by the EEC, whether the instantiable EAS information indicating the EAS instantiation status of the at least one selected EAS is instantiable but is not yet instantiated or the EAS instantiation status of the at least one selected EAS is un-instantiable, and performing, by the EEC, one of: transmitting the EAS discovery message to the at least one EES when the EAS information indicating the EAS instantiation status of the at least one selected EAS is instantiable but is not yet instantiated, and skip transmitting the EAS discovery message to the at least one EES, when the at least one selected EAS is un-instantiable to mitigate wastage of EDN resources.

In an embodiment, the first message from the EES includes one of an EAS discovery response message, and an EAS discovery notification message.

In an embodiment, the first message from the ECS includes a service provisioning response message.

In an embodiment, the method includes transmitting, by the EEC, a second message to notify change in the instantiable EAS information to the EES. Further, the method includes receiving, by the EEC, the change to the instantiable EAS information to the EEC based on the second message.

In an embodiment, the second message includes an EAS discovery subscription request message

In an embodiment, the method includes transmitting, by the EEC, an EAS information provisioning request message to the EES. The EAS information provisioning request message includes an identifier of the at least one selected EAS that is instantiable.

In an embodiment, the instantiable criteria include at least one of a date and time of instantiation of instantiable EAS, a minimum number of trigger requests required to instantiate EAS based on user subscription information. The user subscription information includes at least one of premium user information and user in allow-list.

In an embodiment, the EAS instantiation status indicates at least one of instantiated, instantiable but not instantiated yet, instantiation in progress, and cannot be instantiated.

In an embodiment, the instantiable criteria are available in the first message, when the instantiable EAS information indicates EAS is instantiable but not instantiated yet. Embodiments disclosed herein provide a method for handling dynamic instantiation of EAS in an EDN. The method includes receiving, by an EES, an EES profile from an Edge Computing Service Provider (ECSP) of the EDN. The EES profile includes at least one of a list of EASs or an instantiable criteria upon which EAS of the list of EASs is instantiable. In an embodiment, the method includes performing a registration with an ECS based on the list of EASs and the instantiable criteria available in the EES profile. In an embodiment, the method includes transmitting a first message to an EEC in the EDN. The first message includes instantiable EAS information indicating an EAS instantiation status per EAS of a list of EASs and an instantiable criteria upon which the EAS of the list of EASs is instantiable. In an embodiment, the method includes dynamically triggering at least one EAS from the list of EASs or at least one EES corresponding to at least one EAS from the list of EASs based on the instantiable criteria.

In an embodiment, the method includes receiving, by the EES, a second message to notify change in instantiable EAS information from the EEC. Further, the method includes transmitting, by the EES, the change to the instantiable EAS information to the EEC based on the second request message.

In an embodiment, the method includes receiving, by the EES, a third message from the EEC. The third message includes an identifier of at least one EAS that is instantiable. The at last one EAS is selected by the EEC. Further, the method includes dynamically triggering, by the EES, the at least one selected EAS based on the identifier indicated in the third message.

In an embodiment, the third message is an EAS information provisioning request message.

Embodiments disclosed herein provide a method for handling dynamic instantiation of an EAS in an EDN. The method includes receiving, by an ECS, a registration message from an EES. The registration message includes profile information having a list of EASs and an instantiable criteria upon which EAS of the list of EASs is instantiable. Further, the method includes registering, by the ECS, the EES based on the list of EASs and the instantiable criteria upon which EAS of the list of EASs is instantiable. Further, the method includes transmitting, by the ECS, a first message to an EEC based on the profile information. The first message includes instantiable EAS information indicating an EAS instantiation status per EAS of a list of EASs and an instantiable criteria upon which the EAS of the list of EASs is instantiable.

Embodiments disclosed herein provide an EEC for handling dynamic instantiation of EAS in an EDN. The EEC includes a dynamic EAS instantiation controller connected to a memory and a processor. The dynamic EAS instantiation controller is configured to receive a first message from an ECS or an EES. The first message includes instantiable EAS information indicating an EAS instantiation status per EAS of a list of EASs and an instantiable criteria upon which the EAS of the list of EASs is instantiable. Further, the dynamic EAS instantiation controller is configured to select at least one EAS from the list of EASs or at least one EES to select the at least one EAS based on the instantiable EAS information and the instantiable criteria. Further, the dynamic EAS instantiation controller is configured to perform an EAS discovery of the at least one selected EAS based on the instantiable EAS information.

Embodiments disclosed herein provide an EES for handling dynamic instantiation of an EAS in an EDN. The EES includes a dynamic EAS instantiation controller connected to a memory and a processor. The dynamic EAS instantiation controller is configured to receive an EES profile from an ECSP of the EDN. The EES profile includes at least one of a list of EASs or an instantiable criteria upon which EAS of the list of EASs is instantiable. In an embodiment, the dynamic EAS instantiation controller is configured to perform a registration with an ECS based on the list of EASs and the instantiable criteria available in the EES profile. In another embodiment, the dynamic EAS instantiation controller is configured to transmit a first message to an EEC in the EDN. The first message includes instantiable EAS information indicating an EAS instantiation status per EAS of a list of EASs and an instantiable criteria upon which the EAS of the list of EASs is instantiable. In an embodiment, the dynamic EAS instantiation controller is configured to perform dynamically trigger at least one EAS from the list of EASs or at least one EES corresponding to at least one EAS from the list of EASs based on the instantiable criteria.

Embodiments disclosed herein provide an ECS for handling dynamic instantiation of EAS in an EDN. The ECS includes a dynamic EAS instantiation controller connected to a memory and a processor. The dynamic EAS instantiation controller is configured to receive a registration message from an EES. The registration message includes profile information having a list of EASs and an instantiable criteria upon which EAS of the list of EASs is instantiable. Further, the dynamic EAS instantiation controller is configured to register the EES based on the list of EASs and the instantiable criteria upon which EAS of the list of EASs is instantiable. Further, the dynamic EAS instantiation controller is configured to transmit a first message to an EEC based on the profile information. The first message includes instantiable EAS information indicating an EAS instantiation status per EAS of a list of EASs and an instantiable criteria upon which the EAS of the list of EASs is instantiable.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Embodiments disclosed herein provide a method for handling dynamic instantiation of an EAS in an EDN. The method includes receiving, by an EEC, a first message from an ECS or an EES. The first message includes instantiable EAS information indicating an EAS instantiation status per EAS of a list of EASs and an instantiable criteria upon which the EAS of the list of EASs is instantiable. Further, the method includes selecting, by the EEC, at least one EAS from the list of EASs or at least one EES to select the at least one EAS based on the instantiable EAS information and the instantiable criteria. Further, the method includes performing, by the EEC, an EAS discovery of the at least one selected EAS based on the instantiable EAS information.

The proposed method provides sufficient information to the EES and the EEC for considering prior to initiating dynamic instantiation of EAS, EAS discovery and selection of EAS ID during EAS information provisioning request, to avoid wastage of EDN resources.

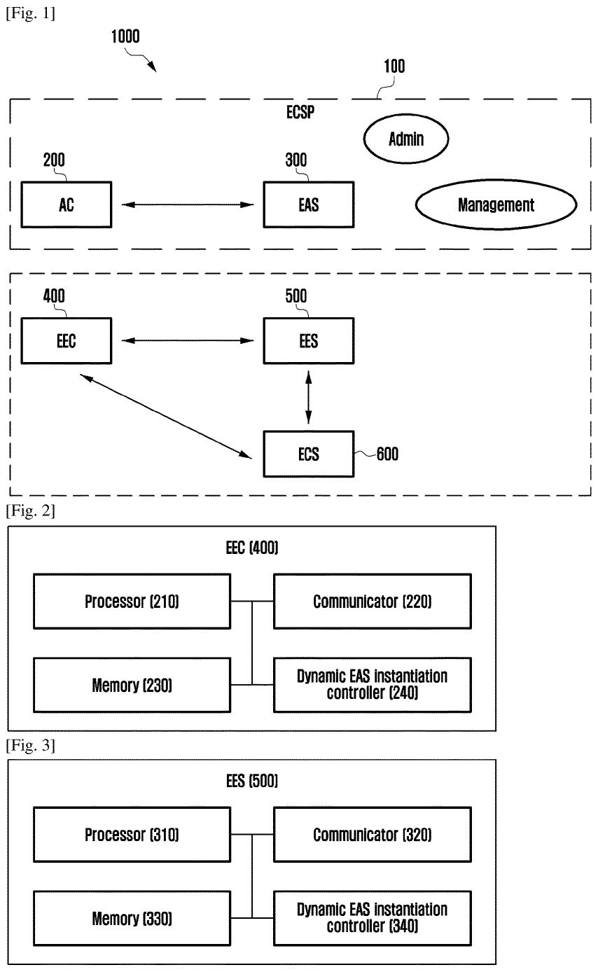

Referring now to the drawings, and more particularly to FIGS. 1 through 12, where similar reference characters denote corresponding features consistently throughout the figures, there are shown example embodiments.

FIG. 1 illustrates an EAS (300) handles dynamic instantiation in an EDN (1000), according to the embodiments as disclosed herein. The FIG. 1 is as simplified version of EDGEAPP architecture as defined in TS 23.558. In an embodiment, the system includes an Application Client (AC) (200), an EAS (300), an EEC (400), an EES (500) and an ECS (600). The ECSP (100) provides the AC (200) and the EAS (300). The EAS (300) is communicated with the EEC (400), the EES (500).

In general, a 3rd Generation Partnership Project (3GPP) develops technical specification (3GPP TS 23.558) for providing application layer architecture and related procedures for enabling edge applications over 3GPP networks. As per the solutions defined in the 3GPP TS 23.558 V18.1.0, the EEC (400) and the EES (500) lack complete information upon which the request to dynamically instantiate EAS (300) can be triggered. Also the current solutions waste resources of the EDN (1000) during dynamic instantiation of EAS and EAS discovery for the EASs that cannot be instantiated by either EEC (400) the or EES (500). The proposed method provides sufficient information to the EES (500) and the EEC (400) for considering prior to initiating dynamic instantiation of EAS, EAS discovery and selection of EAS ID during EAS information provisioning request, to avoid wastage of EDN resources. The Clause and table information is provided from the 3GPP TS 23.558.

### A) Updates to Information Flow Tables:

### Clause 8.2.6 EES Profile

The EES profile includes information about the EES (500) and the services it provides. The EES profile is enhanced to add “Instantiable criteria” information.

In an embodiment, Table 8.2.6-1 EES Profile of 3GPP TS 23.558 can be specified as shown in TABLE 1.

TABLE 1

| Information | | |
|---|---|---|
| element | Status | Description |
| EESID | M (Mandatory) | The identifier of the EES |
| EES Endpoint | M | Endpoint information (e.g. URI, FQDN, IP address) used to communicate with the EES. This |
| | | information is provided to the EEC to connect to the EES. |
| List of EASs | M | List of EAS that are expected to be available from this EES |
| >EASID | M | EASID registered or expected to be registered with the EES. |
| >>InstantiableEAS | O (optional) | The EAS instantiation status per EASID (e.g. instantiated, instantiable but not be |
| information | | instantiated yet, uninstantiable) |
| >>Instantiable | O | The criteria upon which EAS can be instantiated (e.g. based on number of requests, |
| criteria (NOTE) | | specific date and time) |
| EEC registration | M | Indicates whether the EEC is required to register on the EES to use edge services or not. |
| configuration | | |
| EES Provider | O | The identifier of the ECSP that provides the EES Provider. |
| Identifier | | |
| EES Topological | O | The EES serves UEs that are connected to the Core Network from one of the cells included |
| Service Area | | in this service area. EECs in UEs that are located outside this area shall not be served. |
| | | See possible formats in Table 8.2.7-1. |
| EES Geographical | O | The area being served by the EES in Geographical values (as specified in clause 7.3.3.3) |
| Service Area | | |
| List of | O | DNAI(s) associated with the EES. This IE is used as Potential Locations of Applications |
| EESDNAI(s) | | in clause 5.6.7 of 3GPPTS 23.501 [2]. |
| | | It is a subset of the DNAI(s) associated with the EDN, where the EES resides. |
| EES Service | O | Indicates if the EES supports service continuity or not. This IE also indicates which ACR |
| continuity support | | scenarios are supported by the EES. |

(NOTE):
“Instantiable criteria” IE shall be present only when the value of InstantiableEAS information” IE is “instantiable but not be instantiated yet”.

### Clause 8.3.3.3.3: Service Provisioning Response

Table 8.3.3.3.3-1 describes the information elements for service provisioning response from the ECS (600) to the EEC (400). The EDN configuration information is enhanced to add “Instantiable criteria” information.

In an embodiment, Table 8.3.3.3.3-1: Service provisioning response of 3GPP TS 23.558 can be specified as shown in TABLE 2.

TABLE 2

| Information | | |
|---|---|---|
| element | Status | Description |
| Successful | O | Indicates that the service provisioning request was successful. |
| response | | |
| > List of EDN | M | List of EDN configuration information as defined in Table 8.3.3.3.3-2. |
| configuration | | |
| information | | |
| Failure response | O | Indicates that the service provisioning request failed. |
| > Cause | O | Indicates the cause of service provisioning request failure. |

In an embodiment, Table 8.3.3.3.3-2: EDN configuration information of 3GPP TS 23.558 can be specified as shown in TABLE 3.

TABLE 3

| Information | | |
|---|---|---|
| element | Status | Description |
| EDN | M | Information required by the UE to establish connection with the EDN. |
| connection | | |
| information | | |
| (NOTE 1) | | |
| >DNN/APN | M | Data Network Name/Access Point Name |
| > S-NSSAI | O | Network Slice information |
| >EDN | O | The EDN serves UEs that are connected to the Core Network from one of the cells included |
| Topological | | in this service area. See possible formats in Table 8.2.7-1. |
| Service Area | | |
| List of EESs | M | List of EESs of the EDN. |
| >EESID | M | The identifier of the EES |
| >EES Endpoint | M | The endpoint address (e.g. URI, IP address) of the EES |
| > List of EASs | O | List of EAS that are expected to be available from this EES |
| (NOTE 2) | | |
| >>EASID | O | EASID registered or expected to be registered with the EES. |
| >EES | O | The EES serves UEs that are connected to the Core Network from one of the cells included |
| Topological | | in this service area. EECs in UEs that are located outside this area shall not be served. |
| Service Area | | See possible formats in Table 8.2.7-1. |
| >EES | O | The area being served by the EES in Geographical values (as specified in clause 7.3.3.3) |
| Geographical | | |
| Service Area | | |
| > List of | O | DNAI(s) associated with the EES/EAS. This IE is used as Potential Locations of Applications |
| EESDNAI(s) | | in clause 5.6.7 of 3GPP TS 23.501 [2]. |
| >EES Service | O | Indicates if the EES supports service continuity or not. This IE also indicates which ACR |
| continuity | | scenarios are supported by the EES. |
| support | | |
| > EEC | M | Indicates whether the EEC is required to register on the EES to use edge services or not. |
| registration | | |
| configuration | | |
| > Security | O | Indicates the security credential sent by the ECS. The security credential is used by EEC |
| Credential | | to communicate with the EES as specified in 3GPP TS 33.558 [23], clause 6.2. |
| Lifetime | O | Time duration for which the EDN configuration information is valid and supposed to be cached |
| | | in the EEC. |

(NOTE 1):
If the UE is provisioned or pre-configured with URSP rules by the HPLMN, the UE handles the precedence between EDN connection info and URSP rules as defined in 3GPPTS 23.503 [12] clause 6.1.2.2.1. EDN connection info is considered to be part of UE Local Configurations.
(NOTE 2):
EAS information is limited to the EEC requested applications. If no AC profiles were present in the service provisioning request, the EAS information is subject to the ECSP policy (e.g. no EAS information or a subset of EAS information related to the EES).
(NOTE 3):
“Instantiable criteria” IE shall be present only when the value of “InstantiableEAS information” IE is “instantiable but not be instantiated yet”.

### Clause 8.5.3.3 EAS Discovery Response

Table 8.5.3.3-1 describes information elements for the EAS discovery response from the EES (500) to the EEC (400). The EAS discovery response is enhanced to add “Instantiable criteria” information and “Instantiable EAS information”.

In an embodiment, Table 8.5.3.3-1: EAS discovery response of 3GPP TS 23.558 can be specified as shown in TABLE 4.

TABLE 4

| Information | | |
|---|---|---|
| element | Status | Description |
| Successful | O | Indicates that the EAS discovery request was successful. |
| response | | |
| > Discovered EAS | O | List of discovered EAS(s). Each element includes the information described below. |
| list | | |
| >>EAS profile | M | Profile of the EAS. Each element is described in clause 8.2.4 |
| >> Lifetime | O | Time interval or duration during which the information elements in the EAS profile is |
| | | valid and supposed to be cached in the EEC (e.g. time-to-live value for an EAS Endpoint) |
| >>InstantiableEAS | O | The EAS instantiation status per EASID (e.g. instantiated, instantiable but not be |
| information | | instantiated yet, uninstantiable) |
| >>Instantiable | O | The criteria upon which EAS can be instantiated (e.g. based on number of requests, |
| criteria (NOTE 1) | | specific date and time). |
| Failure response | O | Indicates that the EAS discovery request failed. |
| > Cause | O | Indicates the cause of EAS discovery request failure. |

(NOTE 1):
“Instantiable criteria” IE shall be present only when the value of “InstantiableEAS information” IE is “instantiable but not be instantiated yet”.

### Clause 8.5.3.4 EAS Discovery Subscription Request

Table 8.5.3.4-1 describes the information elements for EAS discovery subscription request from the EEC (400) to the EES (500). The EAS discovery subscription request is enhanced to add “Instantiable EAS information”.

In an embodiment, Table 8.5.3.4-1: EAS discovery subscription request of 3GPP TS 23.558 can be specified as shown in TABLE 5.

TABLE 5

| Information | | |
|---|---|---|
| element | Status | Description |
| EECID | M | Unique identifier of the EEC. |
| UE | O | The identifier of the UE (i.e. GPSI or identity token) |
| Identifier | | |
| Event ID | M | Event ID: |
| | | EAS availability change |
| | | EAS dynamic information change |
| Security | M | Security credentials resulting from a successful authorization for the edge computing |
| credentials | | service. |
| Notification | | The Notification target address (e.g. URL) where the notifications destined for the EEC |
| Target | | should be sent to. |
| Address | | |
| EAS | O | Set of characteristics to determine matching EASs (as detailed in Table 8.5.3.2-2). |
| discovery | | Applicable for “EAS availability change” event |
| filters | | |
| EAS | O | List of dynamic information changes (as detailed in Table 8.5.3.4-2) about EAS, the EEC |
| dynamic | | is interested in. |
| information | | Applicable for “EAS dynamic information change” event |
| filters | | |
| EEC Service | O | Indicates if the EEC supports service continuity or not. The IE also indicates which ACR |
| Continuity | | scenarios are supported by the EEC. |
| Support | | |
| Proposed | O | Proposed expiration time for the subscription |
| expiration | | |
| time | | |

In an embodiment, Table 8.5.3.4-2: EAS dynamic information filters of 3GPP TS 23.558 can be specified as shown in TABLE 6.

TABLE 6

| Information | | |
|---|---|---|
| element | Status | Description |
| List of dynamic | M | List of EAS dynamic information required by the EEC per EAS. |
| information | | |
| filters | | |
| >EASID | M | Identifier of the EAS |
| >ACIDs | O | Flag to notify change in list of ACIDs served by the EAS |
| >EAS | O | Flag to notify change in description of the EAS. |
| Description | | |
| >EAS Endpoint | O | Flag to notify change in EAS endpoint |
| >EAS Features | O | Flag to notify any change in features provided by the EAS |
| >EAS Schedule | O | Flag to notify change in availability schedule of the EAS (e.g. time windows) |
| >EAS Service | O | Flag to notify change in change in geographical service area that the EAS serves |
| Area | | |
| >EAS Service | O | Flag to notify change in characteristics of the EAS. |
| KPIs | | |
| >EAS Status | O | Flag to notify change in the status of the EAS (e.g. enabled, disabled, etc.) |
| > Service | O | Flag to notify change in EAS support for service continuity. |
| continuity | | |
| support | | |
| >InstantiableEAS | O | Flag to notify change in instantiableEAS information. |
| information | | |

### Clause 8.5.3.6 EAS Discovery Notification

Table 8.5.3.6-1 describes the information elements for EAS discovery notification from the EES (500) to the EEC (400). The EAS discovery notification is enhanced to add “Instantiable EAS information” and “Instantiable criteria”.

In an embodiment, Table 8.5.3.6-1: EAS discovery notification of 3GPP TS 23.558 can be specified as shown in TABLE 7.

TABLE 7

| Information | | |
|---|---|---|
| element | Status | Description |
| Subscription ID | M | Subscription identifier corresponding to the subscription stored in the EES for the request |
| Event ID | M | Either EAS discovery notification or EAS dynamic information notification |
| EAS list | O | List of discovered EAS profiles. Each element includes the information described below. |
| >EAS profile | M | Profile of the EAS. Each element is described in clause 8.2.4 |
| > Lifetime | O | Time interval or duration during which the information elements in the EAS profile is |
| | | valid and supposed to be cached in the EEC (e.g. time-to-live value for an EAS Endpoint) |
| >InstantiableEAS | O | The EAS instantiation status per EASID (e.g. instantiated, instantiable but not be instantiated |
| information | | yet, uninstantiable) |
| >Instantiable | O | The criteria upon which EAS can be instantiated (e.g. based on number of requests, |
| criteria (NOTE 1) | | specific date and time). |

(NOTE 1):
“Instantiable criteria” IE shall be present only when the value of “InstantiableEAS information” IE is “instantiable but not be instantiated yet”.

### Clause 8.15.3.2 EAS Information Provisioning Request

Table 8.15.3.2-1 describes the information elements for EAS information provisioning request from the EEC (400) to the EES (500).

In an embodiment, Table 8.15.3.2-1: EAS information provisioning request of 3GPP TS 23.558 can be specified as shown in TABLE 8.

TABLE 8

| Information | | |
|---|---|---|
| element | Status | Description |
| EECID | M | The identifier of the EEC. |
| ACID | M | The identifier of the AC. |
| Security | M | Security credentials resulting from a successful authorization for the edge computing |
| credentials | | service. |
| Selected EAS ID | O | The identifier of the selected EAS, which is either instantiated or instantiable. |
| Selected EAS | O | The endpoint of the selected EAS |
| Endpoint | | |
| Request type | O | Request types: |
| | | ACR scenario selection announcement |
| | | ACR scenario selection request |
| Selected ACR | O | The list of ACR scenarios selected by the EEC |
| scenario list | | |
| (see NOTE 1) | | |
| AC Profile | O | AC Profile as described in Table 8.2.2-1 |
| (see NOTE 2, | | |
| NOTE 3) | | |
| EEC Service | O | Indicates if the EEC supports service continuity or not. The IE also indicates which ACR |
| Continuity | | scenarios are supported by the EEC. |
| Support (NOTE 2) | | |

(NOTE 1):
The IE may be present only if Selected EASID and Selected EAS Endpoint are present and Request type is “ACR scenario selection announcement”
(NOTE 2):
The IEs are present only if request type is “ACR scenario selection request”
(NOTE 3):
The IE is present if AC Profile is not shared to EES previously

### B) Updates to Procedures:

B.1) Service provisioning allows configuring the EEC (400) with information about available Edge Computing services, based on the hosting UEs location, service requirements, service preferences and connectivity. This configuration includes the necessary address information for the EEC (400) to establish connection with the EES (500) (s). The invention proposes to update the existing procedures in clause 8.3.3.2.2 Request-response model as below:

When the EDN configuration information includes the instantiable EAS information, the EEC (400) can select one EES (500) corresponding to EAS (300) that can be instantiated or instantiable (and not uninstantiable EAS (300)). For EAS discovery to mitigate the waste of EDN resources EEC (400) considers the instantiable EAS information and the associated instantiable criteria, if the EAS instantiation status corresponding to the EAS ID requested by AC/EEC (400) is instantiable but not yet instantiated.

B.2) Discovery procedures enable entities in an edge deployment to obtain information about EAS (300) and their available services, based on specified criteria of interest. The EAS discovery enables the EEC (400) to obtain information about available EASs of interest. The discovery of the EAS s is based on matching EAS discovery filters provided in the request. The invention proposes to update the existing procedures in clause 8.5.2.2 Request-response model as below:

When the received EAS discovery response includes instantiable EAS information indicating uninstantiable EAS for matching ACID, then the EEC (400) may avoid resending the EAS discovery request for corresponding AC to mitigate the waste of EDN resources.

B.3) The EES (500) may trigger the EAS instantiation dynamically due to e.g., EAS discovery request, UE mobility, upon receiving EEC Registration request containing AC profile. The invention proposes to update the existing procedures in clause 8.12.1 General as below:

The EES (500) may trigger the EAS instantiation dynamically due to e.g., EAS discovery request, UE mobility, upon receiving EEC Registration request containing AC profile.

Upon receiving the EAS discovery request with EAS discovery filter from the EEC (400) or the S-EES during the procedures for EAS discovery or ACR, the EES (500) may fail to discover and select the EAS that matches the UE location and the requesting application characteristics specified in table 8.5.3.2-2 due to no EAS (300) is available or instantiated. The EES (500) may trigger the EAS management system to instantiate the EAS serving the AC (200) in the EDN (1000) corresponding to the EAS (300) that can be instantiable (and not uninstantiable EAS (300)) before returning the EAS information to the EEC (400) or the S-EES, based on the pre-configured dynamic EAS instantiation information about which EAS (300) can be dynamically instantiated at the associated EDN (1000).

FIG. 2 shows various hardware components of the EEC (400), according to the embodiments as disclosed herein. In an embodiment, the EEC (400) includes a processor (210), a communicator (220), a memory (230) and a dynamic EAS instantiation controller (240). The processor (210) is coupled with the communicator (220), the memory (230) and the dynamic EAS instantiation controller (240).

The dynamic EAS instantiation controller (240) receives a first message from the ECS (600) or the EES (500). The first message includes instantiable EAS information indicating the EAS instantiation status per EAS of the list of EASs and the instantiable criteria upon which the EAS (300) of the list of EASs is instantiable. In an embodiment, the first message from the EES (500) includes one of an EAS discovery response message, and an EAS discovery notification message. In another embodiment, the first message from the ECS (600) includes a service provisioning response message.

The instantiable criteria include a date and time of instantiation of instantiable EAS (300), and a minimum number of trigger requests required to instantiate EAS (300) based on user subscription information. The user subscription information includes premium user information and user in allow-list. The instantiable criteria are available in the first message, when the instantiable EAS information indicates the EAS (300) is instantiable but not instantiated yet. Further, the EAS instantiation status indicates at least one of instantiated, instantiable but not instantiated yet, instantiation in progress, and cannot be instantiated.

Further, the dynamic EAS instantiation controller (240) selects the EAS from the list of EASs or the EES (500) to select the EAS (300) based on the instantiable EAS information and the instantiable criteria.

Further, the dynamic EAS instantiation controller (240) performs an EAS discovery of the selected EAS (300) based on the instantiable EAS information. In an embodiment, the dynamic EAS instantiation controller (240) determines whether the instantiable EAS information indicating the EAS instantiation status of the selected EAS (300) is instantiable but is not yet instantiated or the EAS instantiation status of the selected EAS (300) is un-instantiable. Further, the dynamic EAS instantiation controller (240) transmits the EAS discovery message to the EES (500) when the EAS information indicating the EAS instantiation status of the selected EAS (300) is instantiable but is not yet instantiated. Alternatively, the dynamic EAS instantiation controller (240) skips transmitting the EAS discovery message to the selected EES (500), when the selected EAS (300) is un-instantiable to mitigate wastage of EDN (1000) resources.

Further, the dynamic EAS instantiation controller (240) transmits a second message to notify change in the instantiable EAS information to the EES (500). In an example, the second message is the EAS discovery subscription request message. Further, the dynamic EAS instantiation controller (240) receives the change to the instantiable EAS information to the EEC (400) based on the second message.

Further, the dynamic EAS instantiation controller (240) transmits the EAS information provisioning request message to the EES (500). The EAS information provisioning request message includes an identifier of the selected EAS (300) that is instantiable.

The dynamic EAS instantiation controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 2 shows various hardware components of the EEC (400) but it is to be understood that other embodiments are not limited thereon. In other embodiments, the EEC (400) may include less or more number of components. Further, the labels or names of the components are used only for illustrative purpose and does not limit the scope of the invention. One or more components can be combined together to perform same or substantially similar function in the EEC (400).

FIG. 3 shows various hardware components of the EES (500), according to the embodiments as disclosed herein. In an embodiment, the EES (500) includes a processor (310), a communicator (320), a memory (330) and a dynamic EAS instantiation controller (340). The processor (310) is coupled with the communicator (320), the memory (330) and the dynamic EAS instantiation controller (340).

The dynamic EAS instantiation controller (340) receives an EES profile from the ECSP (100) of the EDN (1000). The EES profile includes at least one of the list of EASs or the instantiable criteria upon which EAS (300) of the list of EASs is instantiable. In an embodiment, the dynamic EAS instantiation controller (340) performs the registration with the ECS (600) based on the list of EASs and the instantiable criteria available in the EES profile. In another embodiment, the dynamic EAS instantiation controller (340) transmits the first message to the EEC (400) in the EDN (1000). The first message includes instantiable EAS information indicating the EAS instantiation status per EAS of the list of EASs and the instantiable criteria upon which the EAS (300) of the list of EASs is instantiable. In another embodiment, the dynamic EAS instantiation controller (340) dynamically triggers the EAS (300) from the list of EASs or the EES (500) corresponding to the EAS (300) from the list of EASs based on the instantiable criteria.

In an embodiment, the dynamic EAS instantiation controller (340) receives the second message (e.g., EAS discovery subscription request message or the like) to notify change in instantiable EAS information from the EEC (400). Further, the dynamic EAS instantiation controller (340) transmits the change to the instantiable EAS information to the EEC (400) based on the second request message.

In an embodiment, the dynamic EAS instantiation controller (340) receives the third message (e.g., EAS information provisioning request message or the like) from the EEC (400). The third message includes the identifier of the EAS (300) that is instantiable, where the EAS (300) is selected by the EEC (400). Further, the dynamic EAS instantiation controller (340) dynamically triggers the selected EAS (300) based on the identifier indicated in the third message.

The dynamic EAS instantiation controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (310) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (310) may include multiple cores and is configured to execute the instructions stored in the memory (330).

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although the FIG. 3 shows various hardware components of the EES (500) but it is to be understood that other embodiments are not limited thereon. In other embodiments, the EES (500) may include less or more number of components. Further, the labels or names of the components are used only for illustrative purpose and does not limit the scope of the invention. One or more components can be combined together to perform same or substantially similar function in the EES (500).

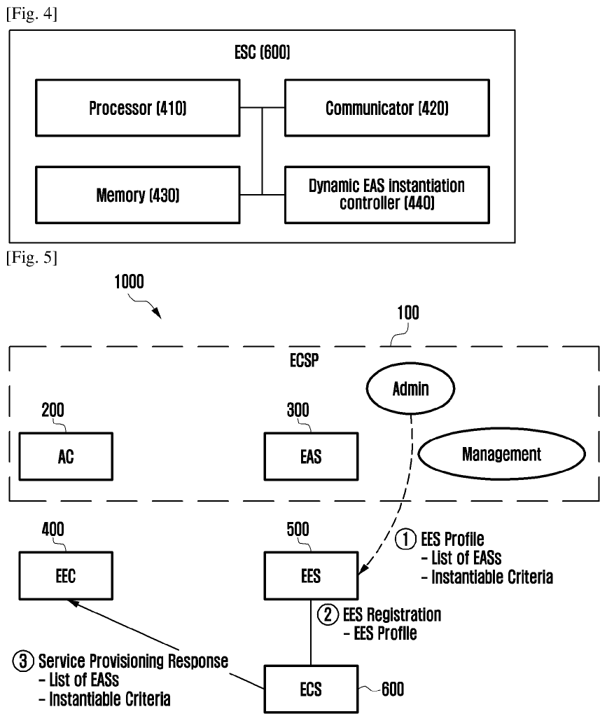

FIG. 4 shows various hardware components of the ECS (600), according to the embodiments as disclosed herein. In an embodiment, the ECS (600) includes a processor (410), a communicator (420), a memory (430) and a dynamic EAS instantiation controller controller (440). The processor (410) is coupled with the communicator (420), the memory (430) and the dynamic EAS instantiation controller controller (440).

The dynamic EAS instantiation controller (440) receives the registration message from the EES (500). The registration message includes the profile information having the list of EASs and the instantiable criteria upon which EAS (300) of the list of EASs is instantiable. Further, the dynamic EAS instantiation controller (440) registers the EES (500) based on the list of EASs and the instantiable criteria upon which EAS (300) of the list of EASs is instantiable. Further, the dynamic EAS instantiation controller (440) transmits the first message to the EEC (400) based on the profile information. The first message includes instantiable EAS information indicating the EAS instantiation status per EAS of a list of EASs and an instantiable criteria upon which the EAS (300) of the list of EASs is instantiable.

The dynamic EAS instantiation controller controller (440) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (410) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (410) may include multiple cores and is configured to execute the instructions stored in the memory (430).

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Although the FIG. 4 shows various hardware components of the ECS (600) but it is to be understood that other embodiments are not limited thereon. In other embodiments, the ECS (600) may include less or more number of components. Further, the labels or names of the components are used only for illustrative purpose and does not limit the scope of the invention. One or more components can be combined together to perform same or substantially similar function in the ECS (600).

FIG. 5 is an example illustration in which the ECS (600) sharing the instantiable criteria to the EEC (400) via the service provisioning in the EDN (1000) is depicted, according to the embodiments as disclosed herein.

At step 1, the EES (500) receives the EES profile from an administrator of the ECSP (100). The EES profile includes at least one of the list of EASs or the instantiable criteria. At step 2, the EES (500) may perform the registration with the ECS (600) based on the list of EASs and the instantiable criteria available in the EES profile. At step 3, the ECS (600) may send the service provisioning response including the list of EASs and the instantiable criteria to the EEC (400). The EEC (400) may select one EES corresponding to the EAS that can be instantiated or instantiable (and not uninstantiable EAS). The EEC may consider the instantiable EAS information and the associated instantiable criteria.

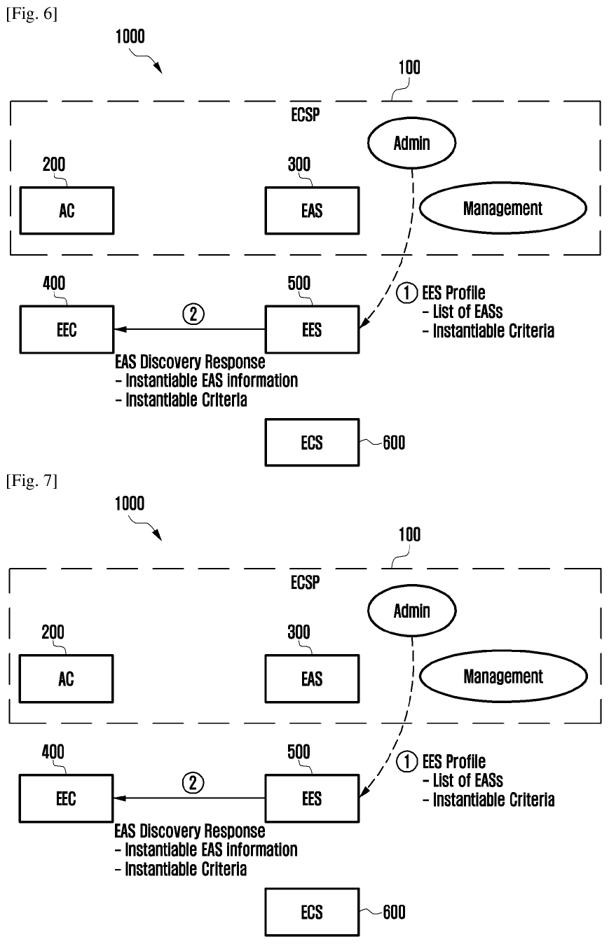

FIG. 6 is an example illustration in which the EES (500) sharing the instantiable criteria to the EEC (400) via the EAS discovery response in the EDN (1000) is depicted, according to the embodiments as disclosed herein. At step 1, the EES (500) receives the EES profile from the admin of the ECSP (100). The EES profile includes at least one of the list of EASs or the instantiable criteria. At step 2, the EES (500) may send the EAS discovery response including the instantiable EAS information and the instantiable criteria to the EEC (400). Hence, the EEC (400) may avoid resending the EAS discovery request for ACIDs matching uninstantiable EAS to mitigate the waste of EDN resources.

FIG. 7 is an example illustration in which the EES (500) sharing the instantiable criteria to the EEC (400) via the EAS discovery notification in the EDN (1000) is depicted, according to the embodiments as disclosed herein. At step 1, the EES (500) receives the EES profile from the admin of the ECSP (100). The EES profile includes at least one of the list of EASs or the instantiable criteria. At step 2, the EES (500) may send the EAS discovery notification message including the instantiable EAS information and the instantiable criteria to the EEC (400). The EEC (400) may avoid resending the EAS discovery request for the ACIDs matching uninstantiable EAS to mitigate the waste of EDN resources.

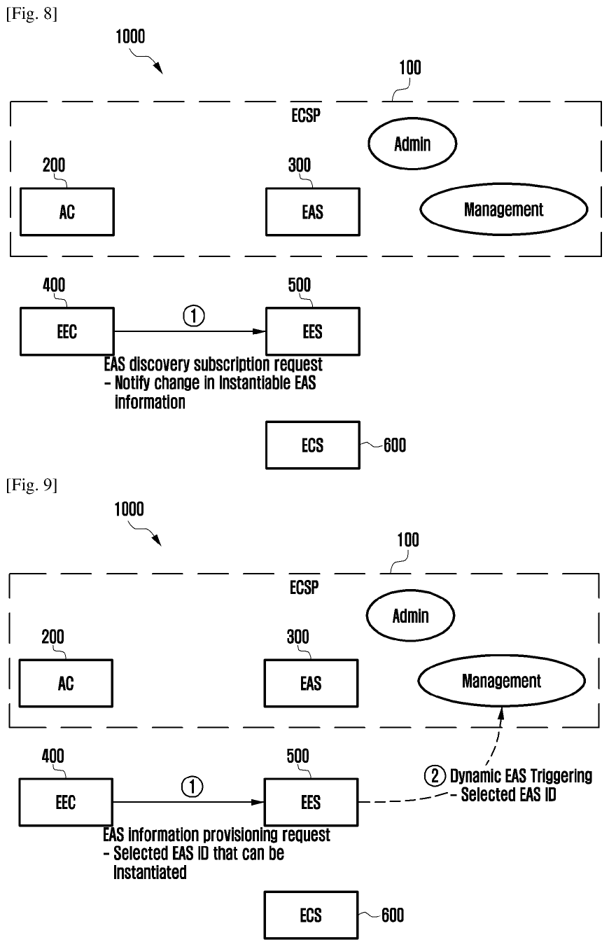

FIG. 8 is an example illustration in which the EEC (400) requesting the EES (500) to notify any change in the instantiable EAS information in the EDN (1000) is depicted, according to the embodiments as disclosed herein. The EEC (400) may send the EAS discovery subscription request indicating a notify change in instantiable EAS information to the EES (500).

FIG. 9 is an example illustration in which the EEC (400) selected EAS information sharing to the EES (500) for dynamic EAS (300) instantiation in the EDN (1000) is depicted, according to the embodiments as disclosed herein. At step 1, the EEC (400) may send the EAS information provisioning request including the selected EAS ID that can be instantiated to the EES (500). At step 2, the EES (500) may perform the dynamic EAS Triggering including the selected EAS ID to the admin of the ECSP (100). The EES (500) may trigger the EAS management system to instantiate the EAS serving the AC (200) in the EDN (1000) corresponding to the EAS (300) that can be instantiable (and not uninstantiable EAS).

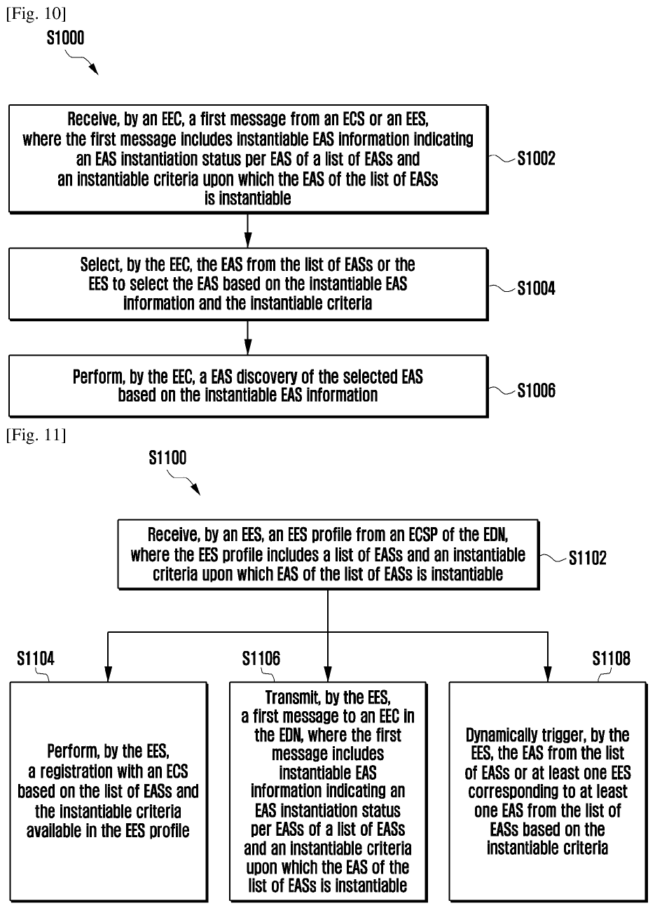

FIG. 10 is a flow chart (S1000) illustrating a method, implemented by the EEC (400), for handling dynamic instantiation of the EAS (300) in the EDN (1000), according to the embodiments as disclosed herein. The operations (S1002-S1006) can be handled by the dynamic EAS instantiation controller (240).

At S1002, the method includes receiving the first message. In an example, the first message can be received from the ECS (600) or the EES (500). The first message includes at least one of the instantiable EAS information indicating the EAS instantiation status per EAS of the list of EASs or the instantiable criteria upon which the EAS (300) of the list of EASs is instantiable. At S1004, the method includes selecting the EAS (300) from the list of EASs or the EES (500) to select the EAS (300) based on at least one of the instantiable EAS information or the instantiable criteria. At S1006, the method includes performing the EAS discovery of the selected EAS (300) based on the instantiable EAS information.

FIG. 11 is a flow chart (S1100) illustrating a method, implemented by the EES (500), for handling the dynamic instantiation of the EAS (300) in the EDN (1000), according to the embodiments as disclosed herein. The operations (S1102-S1108) can be handled by the dynamic EAS instantiation controller (340).

At S1102, the method includes receiving the EES profile from the ECSP (100) of the EDN (1000). The EES profile includes least one of the list of EASs or the instantiable criteria upon which EAS (300) of the list of EASs is instantiable. In an embodiment, at S1104, the method includes performing the registration with the ECS (600) based on the list of EASs and the instantiable criteria available in the EES profile. In an embodiment, at S1106, the method includes transmitting the first message to an EEC (400) in the EDN (1000). The first message includes at least one of instantiable EAS information indicating the EAS instantiation status per EAS of a list of EASs or an instantiable criteria upon which the EAS (300) of the list of EASs is instantiable. In an embodiment, at S1108, the method includes dynamically triggering the EAS (300) from the list of EASs or the EES (500) corresponding to the EAS (300) from the list of EASs based on the instantiable criteria.

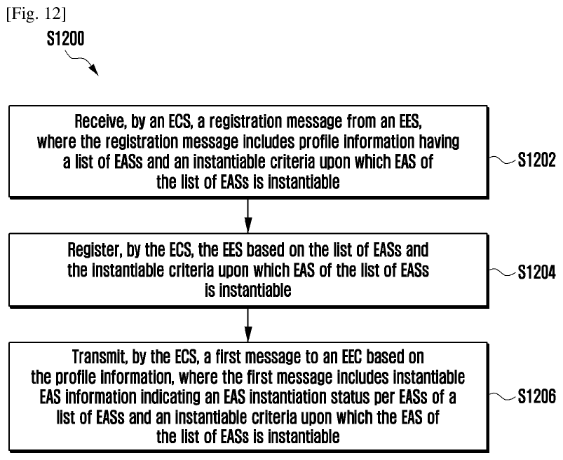

FIG. 12 is a flow chart (S1200) illustrating a method, implemented by the ECS (600), for handling dynamic instantiation of the EAS (300) in the EDN (1000), according to the embodiments as disclosed herein. The operations (S1202-S1206) can be handled by the dynamic EAS instantiation controller (440).

At S1202, the method includes receiving the registration message from the EES (500). The registration message includes the profile information having the list of EASs and the instantiable criteria upon which EAS (300) of the list of EASs is instantiable. At S1204, the method includes registering the EES (500) based on the list of EASs and the instantiable criteria upon which EAS (300) of the list of EASs is instantiable. At S1206, the method includes transmitting the first message to an EEC (400) based on the profile information. The first message includes at least one of instantiable EAS information indicating the EAS instantiation status per EAS of the list of EASs or the instantiable criteria upon which the EAS (300) of the list of EASs is instantiable.

The various actions, acts, blocks, steps, or the like in the flow charts (S1000-S1200) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by an edge enabler client (EEC) for handling instantiation of an edge application server (EAS) (300) in an edge data network (EDN), the method comprising:
receiving, a first message including at least one of instantiable EAS information indicating an EAS instantiation status per EAS of a list of EASs and an instantiable criteria associated with the instantiation of the EAS of the list of EASs;
selecting at least one EAS or at least one EES, based on the at least one of the instantiable EAS information and the instantiable criteria; and
performing an EAS discovery of the at least one selected EAS.

2. The method of claim 1, wherein the performing further comprising:
determining whether the instantiable EAS information indicating the EAS instantiation status of the at least one selected EAS is instantiable but is not instantiated yet; and
transmitting a second message including an identifier of the at least one selected EAS in case that the instantiable EAS information indicating the EAS instantiation status of the at least one selected EAS is instantiable but is not instantiated yet.

3. The method of claim 1,
wherein the first message comprises one of an EAS discovery response message, and an EAS discovery notification message in case that the first message is transmitted from the EES, and
wherein the first message comprises a service provisioning response message in case that the first message is transmitted from the ECS.

4. The method of claim 1,
wherein the instantiable criteria comprise at least one of information on time or information on data associated with an instantiation of an instantiable EAS,
wherein the EAS instantiation status indicates one of instantiated or instantiable but not instantiated yet, and
wherein the instantiable criteria is included in the first message in case that the the EAS instantiation status indicates the instantiable but not instantiated yet.

5. The method of claim 2,
wherein, in case that the first message is an EAS discovery response message and the instantiable EAS information included in the EAS discovery response message indicating that the at least one selected EAS is uninstantiable, a transmission of the second message is skipped to mitigate an waste of EDN resources.

6. The method of claim 1, further comprising:
transmitting, to the EES, an EAS discovery subscription request message for notifying a change in the instantiable EAS information.

7. The method of claim 1,
wherein an EES profile from an edge computing service provider (ECSP) of the EDN to the EES, and
the EES profile comprises at least one of the list of EASs, the instantiable EAS information indicating the EAS instantiation status per EAS of the list of EASs and the instantiable criteria associated with the instantiation of the EAS of the list of EASs.

8. An edge enabler client (EEC) for handling instantiation of an edge application server (EAS) (300) in an edge data network (EDN), the EEC comprising:
a transceiver; and
at least one processor configured to:
receive, via the transceiver, a first message including at least one of instantiable EAS information indicating an EAS instantiation status per EAS of a list of EASs and an instantiable criteria associated with the instantiation of the EAS of the list of EASs,
select at least one EAS or at least one EES, based on the at least one of the instantiable EAS information and the instantiable criteria, and perform an EAS discovery of the at least one selected EAS.

9. The EEC of claim 8, wherein the at least one processor is further configured to:
determine whether the instantiable EAS information indicating the EAS instantiation status of the at least one selected EAS is instantiable but is not instantiated yet, and
transmit a second message including an identifier of the at least one selected EAS in case that the instantiable EAS information indicating the EAS instantiation status of the at least one selected EAS is instantiable but is not instantiated yet.

10. The EEC of claim 8,
wherein the first message comprises one of an EAS discovery response message, and an EAS discovery notification message in case that the first message is transmitted from the EES, and
wherein the first message comprises a service provisioning response message in case that the first message is transmitted from the ECS.

11. The EEC of claim 8,
wherein the instantiable criteria comprise at least one of information on time or information on data associated with an instantiation of an instantiable EAS,
wherein the EAS instantiation status indicates one of instantiated or instantiable but not instantiated yet, and
wherein the instantiable criteria is included in the first message in case that the the EAS instantiation status indicates the instantiable but not instantiated yet.

12. The EEC of claim 9, wherein, in case that the first message is an EAS discovery response message and the instantiable EAS information included in the EAS discovery response message indicating that the at least one selected EAS is uninstantiable, a transmission of the second message is skipped to mitigate an waste of EDN resources.

13. The EEC of claim 8, wherein the at least one processor is further configured to:
transmit, to the EES, an EAS discovery subscription request message for notifying a change in the instantiable EAS information.

14. The EEC of claim 8,
wherein an EES profile from an edge computing service provider (ECSP) of the EDN to the EES, and
the EES profile comprises at least one of the list of EASs, the instantiable EAS information indicating the EAS instantiation status per EAS of the list of EASs and the instantiable criteria associated with the instantiation of the EAS of the list of EASs.
